(19) United States
(12) Patent Application Publication
(10) Pub. No.: US 2023/0199702 A1
(43) Pub. Date: Jun. 22, 2023

(54) WIFI ARCHITECTURE FOR PROXIMATE SENSING

(71) Applicants: Kerstin Johnsson, Palo Alto, CA (US); Alexander Pyattaev, Tampere 11 (FI)

(72) Inventors: Kerstin Johnsson, Palo Alto, CA (US); Alexander Pyattaev, Tampere 11 (FI)

(21) Appl. No.: 17/558,235

(22) Filed: Dec. 21, 2021

(51) Int. Cl. H04W 64/00; H04B 17/382; H04B 17/318

(52) U.S. Cl. CPC H04W 64/003; H04B 17/382; H04B 17/318

(57) ABSTRACT

A sensing architecture and method of determining that a specific movement occurred near the STA are disclosed. WLAN signals such as WiFi are transmitted at a predetermined rate from at least one transmit antenna on a mobile device. The WLAN signals are received by a plurality of receive antennas on a mobile device. The receive antennas are line-of-sight shielded from the transmit antenna. A determination of whether an object is proximate to the mobile device is made based on variations in channel state, as measured at receive antennas. The mobile device state is altered in response to a determination that a specific movement occurred near the STA.

### TECHNICAL FIELD

Embodiments described herein pertain to WLAN communications. Some embodiments relate to proximate sensing using WLAN signals, in particular WiFi signals.

### BACKGROUND

The use of personal communication devices has increased astronomically over the last two decades. The penetration of mobile electronic devices (user equipment/UEs or stations/STAs) in modern society has continued to drive demand for a wide variety of networked devices in a number of disparate environments. The use of networked STAs using various communication protocols has increased in all areas of home and work life. An increasing number of mobile services involve accurate determination of the STA position, of which the most common location method is through the use of a Global Positioning System (GPS) or Global Navigation Satellite System (GNSS). In addition to STA location, location sensing of objects in the vicinity of the STA may be desirable.

### BRIEF DESCRIPTION OF THE DRAWINGS

FIG. 1 shows an exemplary device according to some embodiments described herein.

FIG. 2 shows an exemplary network, according to some embodiments described herein.

FIG. 3 shows exemplary power measurements at the receive antennas of a WiFi-enabled STA, according to some embodiments described herein.

FIG. 4 shows exemplary power measurements at the receive antennas of a WiFi-enabled STA in a noisy environment, according to some embodiments described herein.

FIG. 5 shows exemplary power measurements at the receive antennas of a WiFi-enabled STA in a noise-free environment, according to some embodiments described herein.

FIG. 6 shows exemplary power measurements at the receive antennas of a WiFi-enabled STA in a noisy environment, according to some embodiments described herein.

FIG. 7 shows an exemplary method of detecting object presence, according to some embodiments described herein.

### DETAILED DESCRIPTION

A number of technologies permit a STA to sense and understand the environment. Such technologies include object recognition from images using cameras or detection using signaling of various types, such as ultra-wide bandwidth (UWB), radar, or LIDAR detection. Such technologies, however, all employ additional specialized hardware beyond standard WiFi capabilities used by STAs, such as mobile devices. Analysis of communication channels between WiFi Access Points (APs) and WiFi-enabled client devices (STAs) may be used for sensing. However, the sensing accuracy of such a system varies dramatically as such accuracy is dependent on a number of factors, including the number and location of APs relative to the STA and the amount of noise in the environment. Accordingly, it is desirable to make use of the ubiquitous WiFi capabilities in STAs to provide sensing for a wide range of applications in which coarse sensing is useful. Such course sensing may include, for example, detecting human proximity to a WiFi-enabled device, determining the number of individuals near the WiFi-enabled device, and recognizing gestures for control of the WiFi-enabled device.

A WiFi-based architecture is described that improves the accuracy of a variety of WiFi sensing usages, such as proximity detection (e.g., detecting when an individual approaches or leaves a WiFi-enabled STA) and coarse gesture recognition (e.g., interpreting arm movements to control a WiFi-enabled device). The architecture uses multiple transmit/receive (TX/RX) antennas dispersed across the WiFi-enabled STA rather than between different local WiFi-enabled STAs/APs to isolate the WiFi channel quality from random activity outside the immediate proximity of the WiFi-enabled STA.

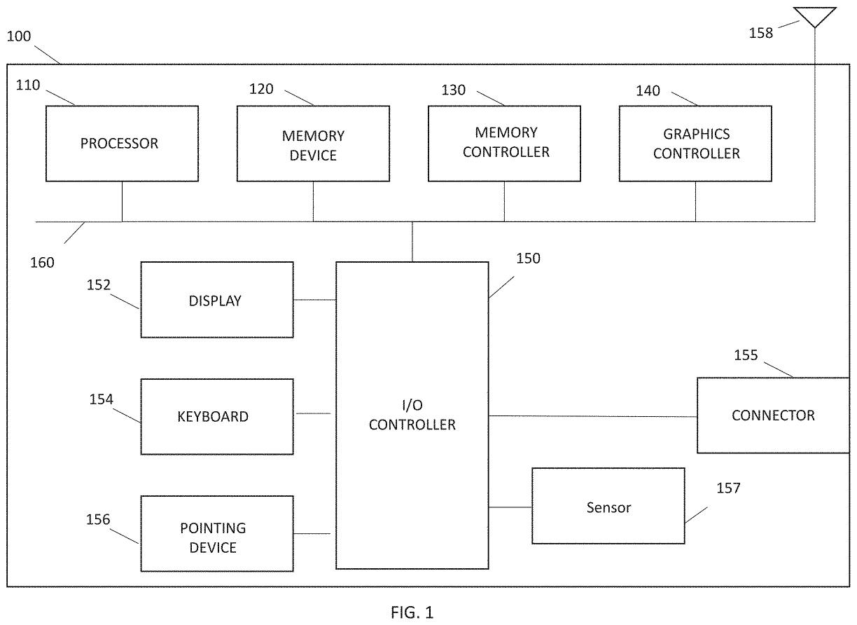

FIG. 1 shows a device, according to some embodiments described herein. The device 100 may be, for example, a STA such as a mobile device such as a smartphone, a laptop computer, or a tablet, an AP, or another electronic device. Some of the components described may not be present dependent on the device 100. Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

As shown in FIG. 1, device 100 may include components located on a circuit board (e.g., printed circuit board (PCB)) 102, such as a processor 110, a memory device 120, a memory controller 130, a graphics controller 140, an I/O controller 150, a display 152, a keyboard 154, a pointing device 156, at least one antenna 158, a connector 155, and a bus 160. Display 152 may include a liquid crystal display (LCD), a touchscreen (e.g., capacitive or resistive touchscreen), or another type of display. Pointing device 156 may include a mouse, a stylus, or another type of pointing device. Bus 160 may include conductive lines (e.g., metal-based traces on a circuit board where the components of device 100 are located). The device 100 may further include one or more sensors 157, such as a global positioning system (GPS) sensor, compass, accelerometer, or other sensor.

Processor 110 may include a general-purpose processor, an application specific integrated circuit (ASIC), or other kinds of processors. Processor 110 may include a CPU. Memory device 120 may include a dynamic random access memory (DRAM) device, a static random access memory (SRAM) device, a flash memory device, phase change memory, a combination of these memory devices, or other types of memory. FIG. 1 shows an example where memory device 120 is a stand-alone memory device separated from processor 110. In an alternative arrangement, memory device 120 and processor 110 may be located on the same die. In such an alternative arrangement, memory device 120 may be an embedded memory in processor 110, such as embedded DRAM (eDRAM), embedded SRAM (eSRAM), embedded flash memory, or another type of embedded memory. The memory device 120 may contain any or all of removable storage and non-removable storage, volatile memory or non-volatile memory.

I/O controller 150 may include a communication module for wired or wireless communication (e.g., communication through one or more antenna 158). Such wireless communication may include communication in accordance with WiFi communication technique, Long Term Evolution Advanced (LTE-A) communication technique, or other communication techniques. I/O controller 150 may also include a module to allow the device 100 to communicate with other devices or systems in accordance with to one or more of the following standards or specifications (e.g., 1/O standards or specifications), including Universal Serial Bus (USB), DisplayPort (DP), High-Definition Multimedia Interface (HDMI), Thunderbolt, Peripheral Component Interconnect Express (PCIe), Ethernet, and other specifications.

Connector 155 may be arranged (e.g., may include terminals, such as pins) to allow the device 100 to be coupled to an external device (or system). This may allow the device 100 to communicate (e.g., exchange information) with such a device (or system) through connector 155. Connector 155 and at least a portion of bus 160 may include conductive lines that conform with at least one of USB, DP, HDMI, Thunderbolt, PCIe, Ethernet, and other specifications.

As shown in FIG. 1, each of processor 110, memory device 120, memory controller 130, graphics controller 140, and I/O controller 150 may be present. However, fewer than all of processor 110, memory device 120, memory controller 130, graphics controller 140, and I/O controller 150 may be present.

FIG. 1 shows the components of the device 100 arranged separately from each other as an example. For example, each of processor 110, memory device 120, memory controller 130, graphics controller 140, and I/O controller 150 may be located on a separate IC (e.g., semiconductor die or an IC chip). In some arrangements, two or more components (e.g., processor 110, memory device 120, graphics controller 140, and I/O controller 150) of the device 100 may be located on the same die (e.g., same IC chip) that may be part of a system on chip, a system in a package, or other electronic devices or systems,

The illustrations described above are intended to provide a general understanding of the structure of different embodiments, and are not intended to provide a complete description of all the elements and features of an apparatus that might make use of the structures described herein. In some arrangements, the device 100 does not have to include a display. Thus, display 152 may be omitted from the device 100. In some arrangements, the device 100 does not have to include any antenna. Thus, antenna 158 may be omitted from the device 100. In some arrangements, the device 100 does not have to include a connector. Thus, connector 155 may be omitted from the device 100.

The memory device 120 may include a non-transitory machine readable medium (hereinafter simply referred to as machine readable medium) on which is stored one or more sets of data structures or instructions (e.g., software) embodying or utilized by any one or more of the techniques or functions described herein. The term “machine readable medium” may include a single medium or multiple media (e.g., a centralized or distributed database, and/or associated caches and servers) configured to store the one or more instructions. The term “machine readable medium” may include any medium that is capable of storing, encoding, or carrying instructions for execution by the device 100 and that cause the device 100 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions may further be transmitted or received over a communications network using a transmission medium utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, peer-to-peer (P2P) networks, a next generation (NG)/5^{th} generation (5G) standards among others. In an example, the network interface device may include one or more physical connectors (e.g., Ethernet, coaxial, or phone connectors) or one or more antennas to connect to the transmission medium.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

In the detailed description and the claims, a list of items joined by the term “at least one of” may mean any combination of the listed items. For example, if items A and B are listed, then the phrase “at least one of A and B” means A only; B only; or A and B. In another example, if items A, B, and C are listed, then the phrase “at least one of A, B and C” means A only; B only; C only; A and B (excluding C); A and C (excluding B); B and C (excluding A); or all of A, B, and C. Item A may include a single element or multiple elements. Item B may include a single element or multiple elements. Item C may include a single element or multiple elements.

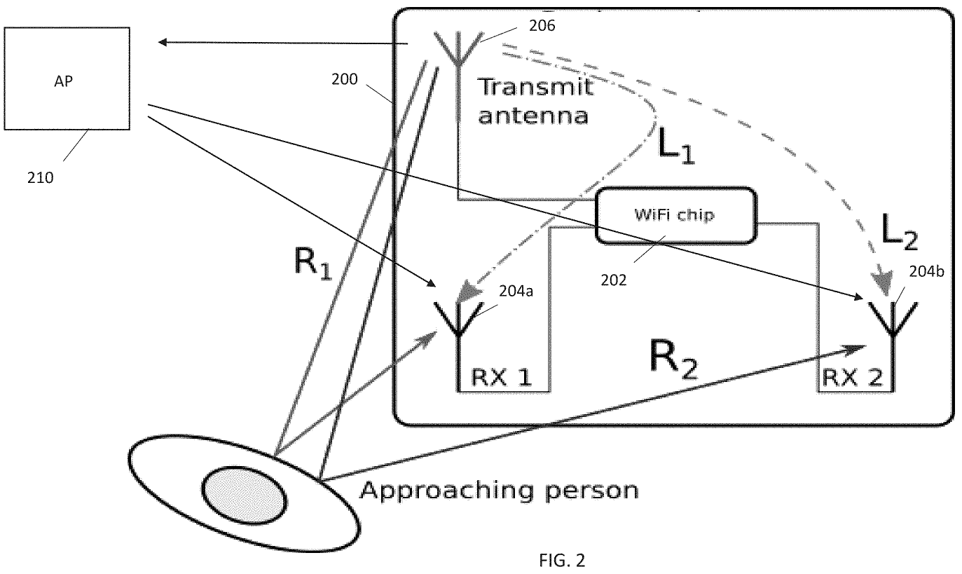

FIG. 2 shows a network, according to some embodiments described herein. The network may contain both a WiFi-enabled STA 200 and, optionally, an access point (AP) 210 with which the WiFi-enabled STA 200 communicates through WiFi and/or other communication protocols. The WiFi-enabled STA 200 and AP 210 shown may contain components similar to those of the device 100 of FIG. 1, but that are not included for convenience. As shown, only a very limited number of elements of FIG. 1 are shown in the WiFi-enabled STA 200, including a transceiver (such as a WiFi chip 202) that is used to transmit and receive WiFi communications through transmit (TX) and receive (RX) chains that are isolated from each other, e.g., by means of antenna patterns (nulls in specific directions), antenna polarization, and/or RF shielding. In particular, the WiFi chip 202 may transmit using one or more transmit antennas 206 and receive through one or more (shown as multiple) receive antennas 204a, 204b. Note that although only three antennas are shown, the WiFi-enabled STA 200 may include any number of antennas, each of which may be predetermined as a transmit or receive antenna or may be used in both modes, as controlled by a processor.

The transmit and receive antennas 204a, 204b, 206 may include one or more directional or omnidirectional antennas, for example, dipole antennas, monopole antennas, patch antennas, loop antennas, microstrip antennas or other types of antennas suitable for communication of RF signals. In some multiple-input multiple-output (MIMO) embodiments, the transmit and receive antennas 204a, 204b, 206 may be effectively separated to take advantage of spatial diversity and the different channel characteristics that may result.

As shown in FIG. 2, the transmit antenna 206 may transmit WiFi signals from the WiFi chip 202, which reflects off of an object (shown in FIG. 2 as an approaching person). The WiFi signals may be transmitted at any WiFi frequency, e.g., in the 2.4 GHz band. The WiFi signals may have any bandwidth, although the measurements may improve with increasing bandwidth. The reflected WiFi signals may be received at the receive antennas 204a, 204b. When the object, which may be a person or an appendage such as an arm, for example, is present near the transmit and receive antennas 204a, 204b, 206, the presence of the object may alter the channel properties (perceived by hardware as channel state information (CSI)), such as the received signal power. For example, the presence of the object may alter the power of first- and second-order reflected paths, which include, for example, scatted signal from the transmit antenna 206. In other embodiments, other variations in CSI characteristics may be used such as phase information. As above, although the WiFi chip 202 is described, any WLAN chip may be used in other embodiments.

The power of the WiFi signals on the LOS paths can often swamp that of other paths, even the strongest first-order reflected paths, making the WiFi signals from the other paths undetectable. Thus, to analyze the CSI data from first- and second-order reflected paths (paths with more reflections are usually too weak to be useful) to detect proximity, recognize arm gestures, etc., the transmit and receive antennas 204a, 204b, 206 may be positioned relatively far apart (e.g., at least about ½ wavelength of the WiFi signal being transmitted), as well as shielding positioned between the transmit and receive antennas 204a, 204b, 206 to dampen the LOS signal paths and enable detection of the first- and second-order reflected paths. The shielding may be physical (metallic) shielding and/or may be based on antenna pattern. That is, the transmission pattern of the transmit antenna 206 and/or reception pattern by the receive antennas 204a, 204b may be designed to dampen the direct paths between the transmit and receive antennas 204a, 204b, 206. Note that while CSI is described herein, other measurement parameters may be used, including signal-to-noise ratio (SNR), Signal-to-Noise-or-Interference Ratio (SINR) or Received signal power (RxPower), for example.

In some embodiments, any WiFi signal containing control information or data (control or data WiFi frame) may be used. The WiFi signals to determine object presence may be transmitted periodically, continuously, or when activated, e.g., by a remote signal. The WiFi signals may have specific characteristics (e.g., hardware address/MAC address, specific coding or timings) that allow them to be identified as detection signals when received by the STA.

The characteristics of multiple detection signals may be combined and the signal strength variations (and/or other characteristic(s)) used to determine whether a moving object is present. In some embodiments, the pattern of the signal strength received by one or more of the receive antennas may be used to determine the presence of a moving object or even the specific motion of the object (such as a hand gesture).

In some embodiments, artificial intelligence (AI)/machine learning (ML) may be used to train a processor in the WiFi-enabled STA 200 and/or external to the WiFi-enabled STA 200. The AI/ML process may include both a training mode to train the AI/ML model and an inference mode to use once the AI/ML model is sufficiently trained. In some embodiments, the AI/ML model may be an artificial neural network (ANN). For example, in some cases, initial training may be performed remotely, and the initial ANN parameters transferred to local computing resources for updating when new information is obtained in the inference mode.

In some cases, the variations in the CSI of the WiFi signals transmitted by the transmit antenna 206 and subsequently received by the receive antennas 204a, 204b under specific conditions (e.g., objects and movements in locations near the WiFi-enabled STA 200) may be used to train the AI/ML model. The objects may be of any type and size, and the algorithm may automatically train based on the various stationary and moving objects.

Moreover, in some cases, the level of accuracy for the parameters determined during training may depend on the amount of processing resources available, which includes both computing power and available time. That is, the training may result in the same level of accuracy using less computing power and a larger amount of time as more computing power and a smaller amount of time, thereby permitting selection of the appropriate processing resources. For example, initial training may be performed in the cloud to a relatively high level of accuracy and the training parameters provided to the WiFi-enabled STA 200. If further training is used within the WiFi-enabled STA 200, the accuracy level of the parameters may be reduced due to the reduced computing resources for training of a generic ANN within the WiFi-enabled STA 200. In some embodiments, the training or inference to provide the corrections may be performed on a dedicated chip within the WiFi-enabled STA 200 or may be provided on a main central processing unit. Selection of the processing resources for training may depend on the permitted amount of time to train as calls to the main central processing unit may result in longer time being used than when a dedicated chip is used. This training may be used to not only detect the presence of a (moving) object, but also specific object motion—such as gesture interpretation.

The detection may be used to trigger use/adjustment of one or more characteristics of the STA 200, for example activating the STA (e.g., powering on/initiating exit from sleep mode), activating the display on the STA 200, initiating an app on the STA 200 (such as initiating a near field communication (NFC) application), or adjusting a parameter of an app (e.g., enlarging text a screen) based on a gesture.

Note that CSI based sensing where Tx antenna is located on the same device as Rx antennas is similar to RADAR in that the CSI is primarily impacted by objects that are close to the STA. As a result, the single-node CSI sensing is more robust to random noise sources in the environment as compared to similar approaches that rely on AP transmissions as signal source.

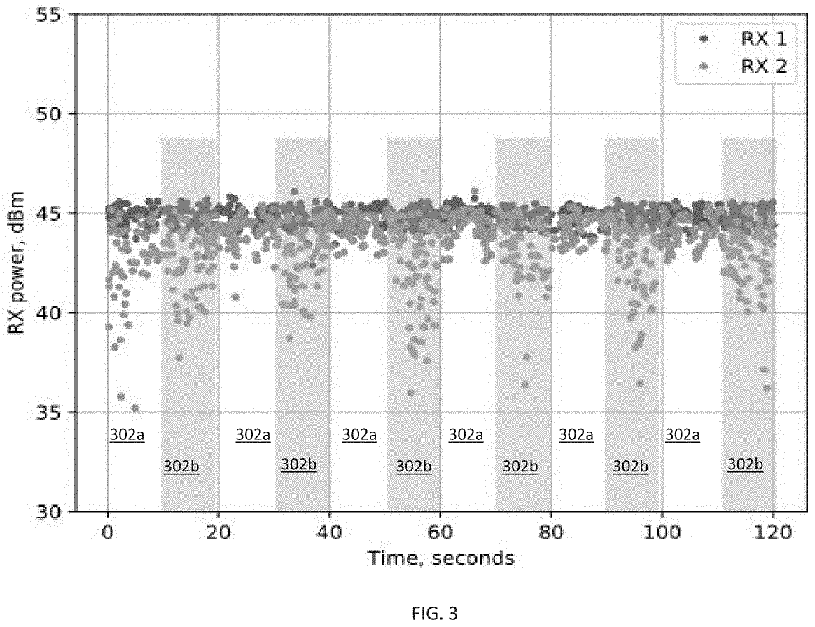

FIG. 3 shows power measurements at the receive antennas of a WiFi-enabled STA, according to some embodiments described herein. In particular, FIG. 3 illustrates measurements using one transmit antenna and two receive antennas on the same WiFi-enabled device operating at 5 GHz carrier. In various embodiments, any number of transmit and receive antennas may be used, as long as there is at least one of each kind. The power of the signals transmitted by the transmit antenna, and, consequently, reflected off the environment, is collected on each of the receive antennas independently at rate of 10 measurements per second. In some embodiments, the rate may be different. The measurements include movement by an individual towards and away from the STA at repeated 10 second intervals. In particular, regions 302a indicate situations in which the individual is not within the proximity of the STA; regions 302b indicate situations in which the individual is within the proximity of the STA. As clearly seen in FIG. 3, distinct regions of high vs. low CSI variability exist in the measured data. Such CSI variability corresponds to different proximity situations of the individual with respect to the STA and are easily classified by AI/ML algorithms accordingly.

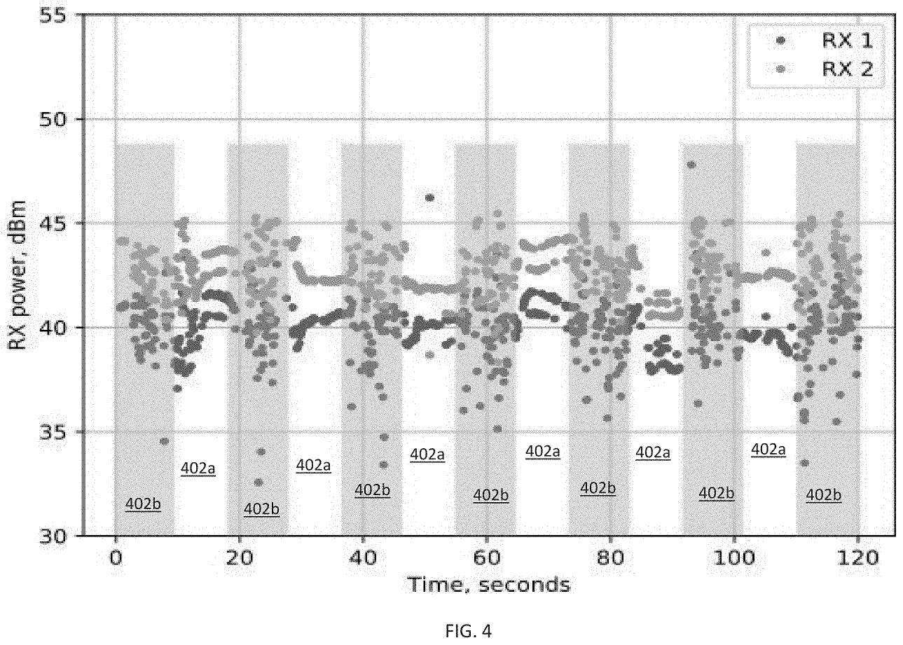

FIG. 4 shows power measurements at the receive antennas of a WiFi-enabled STA in a noisy environment, according to some embodiments described herein. The measurement conditions of FIG. 3 were duplicated, except that noise sources were added to the environment. The noise sources included additional individuals present outside the desired proximity detection range. As in FIG. 3, regions 402a indicate situations in which the individual was not within the proximity of the STA; regions 402b indicate situations in which the individual was within the proximity of the STA. As indicated, the detectability of human proximity to the STA remains unchanged unless the noise source is close to the STA. That is, the regions 402b still demonstrate significantly greater CSI variability than the regions 402a despite the presence of random noise sources farther away in the test environment.

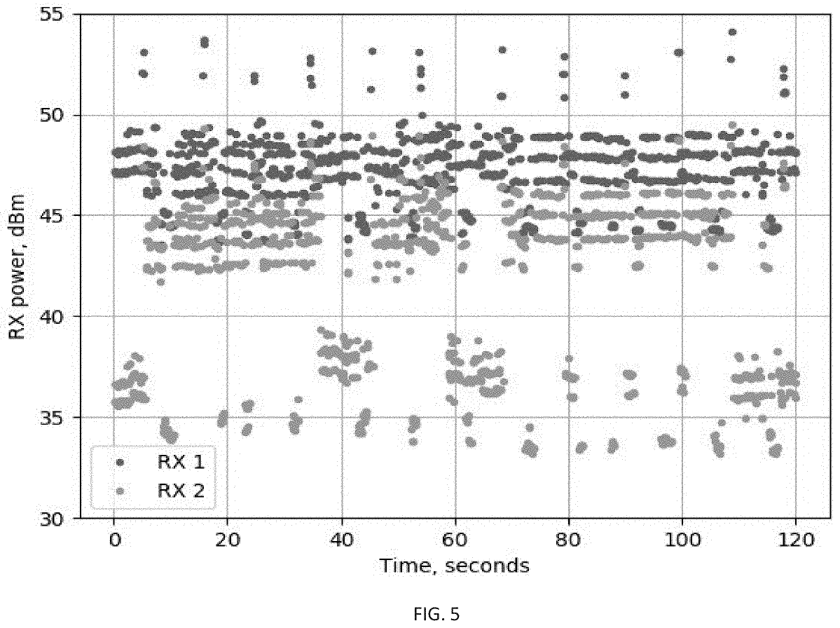

FIG. 5 shows power measurements at the receive antennas of a WiFi-enabled STA in a noise-free environment, according to some embodiments described herein. In the measurements shown in FIG. 5, the conditions under which the measurements for FIG. 3 were duplicated, except that the transmit antenna was provided on an AP which was positioned at various locations throughout the environment. In this “STA+AP” WiFi sensing architecture, eliminating all noise sources is nearly impossible, but more importantly, even in a noise-free environment, the impact of human proximity on the CSI data is not clearly apparent.

FIG. 5 shows the CSI data at the receive antennas on the STA when the AP is in a location representative of the various locations tested in the test environment. As FIG. 5 shows, there is no distinct difference in CSI data across the entire testing period. In this WiFi sensing architecture, when the transmit antenna is on an AP and the receive antennas are on the STA, the detectability of human approach depends significantly on the position of the AP relative to the approach path of the individual.

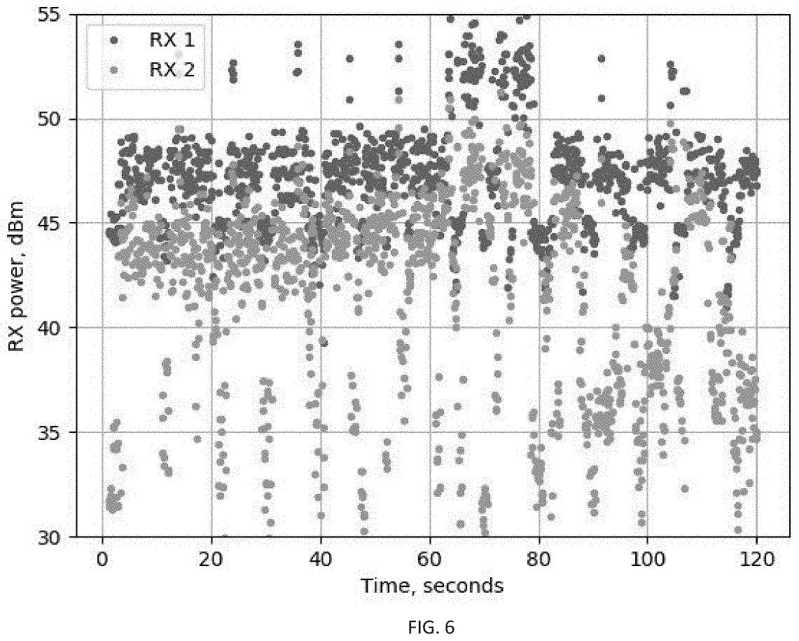

FIG. 6 shows power measurements at the receive antennas of a WiFi-enabled STA in a noisy environment, according to some embodiments described herein. In the measurements shown in FIG. 6, the conditions under which the measurements for FIG. 5 were duplicated, except that noise sources similar to those provided in FIG. 4 were added to the environment. The random noise sources inserted into the environment changed the CSI dramatically. The resulting data, as can be seen, was extremely noisy. Such data would likely be of little value even with AI/ML processing.

Note that in all of the above cases, the amount of noise in the environment of the WiFi STA may be determined over time, and an ANN may be trained to adjust detection based on the power distribution based on the amount of noise to determine whether a moving object is proximate to the WiFi STA (or other implementations such as gesture detection).

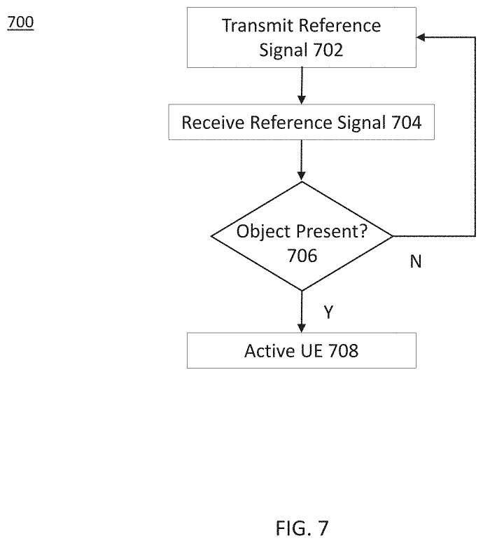

FIG. 7 shows a method of detecting object presence, according to some embodiments described herein. The method 700 may be performed by the STA and/or AP shown and described in the above figures. Embodiments of the method 700 may thus include additional or fewer operations or processes in comparison to what is illustrated in FIG. 7. In addition, embodiments of the method 700 are not necessarily limited to the chronological order that is shown in FIG. 7.

At operation 702, one or more reference signals (such as WiFi signals) are transmitted from one or more transmission antennas. The transmission antennas may be disposed on the STA. The reference signals may be transmitted at a predetermined or adjustable rate and may have specific signal characteristics. The rate of transmission may be dependent, for example, on the events detected previously in the environment.

At operation 704, the reference signals are received by multiple receive antennas disposed on the STA.

At operation 706, a processor in the STA may determine whether a specific movement occurred near the STA (e.g., a person within a few feet). The processor may combine one or more characteristics of one or more of the most recent signals to determine characteristics of the channel and whether a specific movement was present. The determination may be based solely on the WiFi-based detection or may be used in conjunction with other detection techniques (e.g., image recognition or other RF detection techniques such as RADAR). The processor may also be able to determine the size and/or shape of the moving object (and thus the type of moving object—e.g., an arm) based on the magnitude of changes in the CSI received by the different receive antennas over a relatively short amount of time.

If the processor determines that none of the targeted movements occurred near the STA, the method 700 may return to operation 702. If the processor determines the presence of a targeted movement near the STA, at operation 708 one or more of the modules or apps of the STA may be activated.

The above description and the drawings illustrate some embodiments of the inventive subject matter to enable those skilled in the art to practice the embodiments of the inventive subject matter. Other embodiments may incorporate structural, logical, electrical, process, and other changes. Examples merely typify possible variations. Portions and features of some embodiments may be included in, or substituted for, those of others. Many other embodiments will be apparent to those of skill in the art upon reading and understanding the above description.

The Abstract is submitted with the understanding that it will not be used to limit or interpret the scope or meaning of the claims. The following claims are hereby incorporated into the detailed description, with each claim standing on its own as a separate embodiment.

What is claimed is:

1. A wireless local area network (WLAN) station (STA) comprising:
at least one transmit antenna configured to transmit a plurality of WLAN signals within a predetermined amount of time;
at least one receive antenna configured to receive the WLAN signals transmitted; and
a processor configured to:
determine at least one characteristic of each of the WLAN signals,
determine whether a specific movement is proximate to the WLAN STA based on a change in the at least one characteristic of each of the WLAN signals, and
adjust a state of the WLAN STA in response to a determination that the specific movement is proximate to the WLAN STA.

2. The WLAN STA of claim 1, further comprising shielding arranged between the at least one transmit antenna and the at least one receive antenna to block or suppress line-of-sight transmissions between the at least one transmit antenna and the at least one receive antenna.

3. The WLAN STA of claim 1, wherein the at least one transmit antenna and at least one receive antenna are arranged to suppress line-of-sight transmissions between the at least one transmit antenna and the at least one receive antenna.

4. The WLAN STA of claim 1, wherein the at least one characteristic comprises received power of the WLAN signals.

5. The WLAN STA of claim 1, wherein the at least one receive antenna comprises a plurality of receive antenna disposed at least % wavelength of the WLAN signals apart.

6. The WLAN STA of claim 1, wherein the processor is configured to at least one of train or use an artificial neural network (ANN) to determine whether the specific movement is proximate to the WLAN STA based on variations in channel state information (CSI) of the WLAN signals received.

7. The WLAN STA of claim 6, wherein the processor is configured to train and use the ANN to determine at least one of a size, shape, or type of a moving object that produced the specific movement based on the variations in the CSI of the WLAN signals received.

8. The WLAN STA of claim 6, wherein the processor is configured to train and use the ANN to recognize gestures for control of the WLAN STA based on the variations in the CSI of the WLAN signals received by the at least one receive antenna.

9. The WLAN STA of claim 6, wherein the processor is further configured to:
determine an amount of noise in an environment of the WLAN STA, and
train and use the ANN to adjust detection based on the variations in the CSI based on the amount of noise to determine whether the specific movement is proximate to the WLAN STA.

10. The WLAN STA of claim 1, wherein the processor is configured to:
determine a gesture for control of the WLAN STA based on channel state information (CSI) of WLAN signals received by the at least one receive antenna, and
to adjust the state of the WLAN STA, initiate or adjust a parameter of an app on the WLAN STA based on the gesture.

11. The WLAN STA of claim 1, wherein the at least one characteristic comprises channel state information (CSI) of the WLAN signals received, the CSI comprising per-subcarrier phase and magnitude information.

12. A mobile device, comprising:
a multiple-input multiple-output (MIMO) transceiver;
at least one transmit antenna configured to transmit WLAN signals;
a plurality of receive antennas configured to receive WLAN signals transmitted by at least one transmit antenna and provide the WLAN signals through the transceiver; and
a processor configured to:
determine channel state information (CSI) of each of the WLAN signals,
determine whether a specific movement occurred near the mobile device based on variations in the CSI of the WLAN signals, and
alter a state of the mobile device in response to a determination that the specific movement occurred near the mobile device.

13. The mobile device of claim 12, further comprising shielding arranged between the at least one transmit antenna and the at least one receive antenna to block line-of-sight transmissions between the at least one transmit antenna and the at least one receive antenna.

14. The mobile device of claim 12, wherein the at least one transmit antenna and at least one receive antenna are arranged to block line-of-sight transmissions between the at least one transmit antenna and the at least one receive antenna.

15. The mobile device of claim 12, wherein the CSI comprises per-subcarrier phase and magnitude information.

16. The mobile device of claim 12, wherein the processor is further configured to determine that the WLAN signals are those transmitted by the mobile device.

17. The mobile device of claim 12, wherein the processor is configured to train and use an artificial neural network (ANN) to determine that the specific movement occurred near the mobile device based on the variations in the CSI of the WLAN signals.

18. A method of detecting a specific movement near a station (STA), the method comprising:
transmitting WLAN signals from at least one transmit antenna at a predetermined rate;
receiving the WLAN signals by a plurality of receive antennas in a mobile device;
determining whether the specific movement occurred near the mobile device based on variations in channel state information (CSI) of the WLAN signals; and
altering a state of the mobile device in response to a determination that the specific movement occurred near the STA.

19. The method of claim 18, wherein the receive antennas are line-of-sight shielded from the at least one transmit antenna.

20. The method of claim 18, further comprising at least one of training or using an artificial neural network (ANN) to determine that the specific movement occurred near the mobile device based on the variations in the CSI of the WLAN signals.
